(19) United States
(12) Patent Application Publication
(10) Pub. No.: US 2018/0241736 A1
(43) Pub. Date: Aug. 23, 2018

(54) ACCESS POINT KEY BASED SERVICE SYSTEM

(71) Applicant: Ajotek LLC, San Francisco, CA (US)

(72) Inventor: Giuseppe Sircana, San Francisco, CA (US)

(73) Assignee: Ajotek LLC, San Francisco, CA (US)

(21) Appl. No.: 15/900,387

(22) Filed: Feb. 20, 2018

Related U.S. Application Data
(60) Provisional application No. 62/460,656, filed on Feb. 17, 2017.

(51) Int. Cl. H04L 29/06

(52) U.S. Cl. CPC H04L 63/083; H04L 63/107; H04L 63/06

(57) ABSTRACT

A system and method and user device for access point key based services. The system includes one or more servers and one or more access points. The servers are configured to maintain a data structure of a plurality of service information for a plurality of services. The servers are also configured to maintain a private network for a premise, the premise hosting one or more of the plurality of the services. The one or more access points are configured by the servers n a relation to the premise to indicate proximity to the premise, each access point having an access point key. The servers are further configured to authorize a user upon recognition of an access point key, and to allow only the authorized user to communicate with the private network. The user interacts with an access point to obtain authorization from a user device, and accesses the one or more of the plurality of services from the user device upon authorization.

### CROSS-REFERENCE TO RELATED APPLICATIONS

This application claims the benefit of U.S. Provisional Application No. 62/460,656 (Attorney docket AJTKP001P), entitled “ACCESS POINT KEY BASED SERVICE SYSTEM,” filed on Feb. 17, 2017, which is incorporated by reference herein in its entirety for all purposes.

### TECHNICAL FIELD

The disclosed subject matter relates generally to access point key based or configured services and, more particularly, to a system and method for providing localized service access based on authorization with access point keys.

### BACKGROUND

Access point key based service systems help a user identify, interact and transact with a localized service that is hosted on a private network and accessible upon authorization with keys associated with access points of the system. The current systems allow the user to transact with the service by interacting with a middle entity, e.g., a sales clerk, to place an order of and pay for the service.

Current systems' reliance on a middle entity contributes to draw-backs such as long user waiting time, lack of efficiency due to a possible mismatch between the number of users and the number of middle entities to serve the users. It is desirable to have a solution that decreases or eliminates the involvement and facilitation of such a middle entity to provide direct transaction between the user and the service of interest to the user.

### SUMMARY

In general, in one aspect, embodiments of the present disclosure relate to a system for providing access point key based services. The system includes one or more servers and one or more access points. The servers are configured to maintain a data structure of a plurality of service information for a plurality of services. The servers are also configured to maintain a private network for a premise, the premise hosting one or more of the plurality of the services. The one or more access points are configured by the servers in a relation to the premise to indicate proximity to the premise, each access point having an access point key. The servers are further configured to authorize a user upon recognition of an access point key, and to allow only the authorized user to communicate with the private network. The user interacts with an access point to obtain authorization from a user device, and accesses the one or more of the plurality of services from the user device upon authorization.

Other aspects of the present disclosure will be apparent from the following detailed description and the appended claims.

### BRIEF DESCRIPTION OF DRAWINGS

The disclosed embodiments may be better understood by referring to the figures in the attached drawings, as provided below.

FIG. 1A illustrates an example data system in accordance with one or more embodiments of the present disclosure.

FIG. 1B illustrates an example application in accordance with one or more embodiments of the present disclosure.

FIG. 1C illustrates an example user order and BC sequence in accordance with one or more embodiments of the present disclosure.

FIG. 2 illustrates an example configuration of access points in the context of an example business establishment that does not allow drive-through service in accordance with one or more embodiments of the present disclosure.

FIG. 3 illustrates an example configuration of access points in the context of an example business establishment that allow only drive-through service in accordance with one or more embodiments of the present disclosure.

FIG. 4 illustrates an example use of localizing capabilities to provide access to services in the context of an example business establishment where no physical access points are configured.

FIGS. 5A and 5B illustrate a diagram of a computing system in accordance with one or more embodiments of the present disclosure.

Features, elements, and aspects that are referenced by the same numerals in different figures represent the same, equivalent, or similar features, elements, or aspects, in accordance with one or more embodiments.

### DETAILED DESCRIPTION

Specific embodiments of the present disclosure will now be described in detail with reference to the accompanying figures. Like elements in the various figures are denoted by like reference numerals for consistency.

In the following detailed description of embodiments of the present disclosure, numerous specific details are set forth in order to provide a more thorough understanding of the present disclosure. However, it will be apparent to one of ordinary skill in the art that the present disclosure may be practiced without these specific details. In other instances, well-known features have not been described in detail to avoid unnecessarily complicating the description.

Embodiments of the present disclosure provide a system and method for providing localized access to services available on a private network, as well as a user device which authorizes with the system by recognizing access point keys when in proximity. In some embodiments, the proximity is recognized on a network of NFC (Near Field Communication) technology by a user device having NFC chipsets or NFC components. In some other embodiments, the proximity is recognized by scanning a graphic code, QR code, bar code, or the like. In some embodiments, once authorized, the system transmits and installs an interface, e.g., application, to the user device to allow access to the localized service hosted in the system. In some embodiments, a user of the user device is pre-registered with the system so that upon detecting proximity to the localized service, the system further verifies and authenticate the user for service access. With the capability to verify user registrations, pre-stored information such as user's favorites, preference of seating choice, etc. can be transmitted together as part of the interface to assist the user to interact with the localized services. In some other embodiments, the afore-described user data is stored on user's personal device so that, upon installation of a service application, the user data populates the corresponding data structure utilized of the service application to achieve the same purpose.

In some embodiments, access to the localized service is further controlled by sub-degree of proximity to the service. For example, upon the first recognition of a first sub-degree of proximity to the service, the user is authorized only to access the service to a limited extent. It is upon an additional recognition of a second sub-degree of proximity that the user is authorized to access the full content of the localized service. Take a restaurant service for example, after scanning a graph code at a bar section of the restaurant while waiting to be seated at a table, the user is only allowed to make selections from the drink menu. It is only after the user is seated and scans a graph code in the dining area again that the meal menu becomes accessible to the user.

In some embodiments, access to the localized service is further controlled by a timing mechanism to best ensure continued proximity to the service. For example, upon the first recognition of proximity to the service, the user is authorized to access the service to the extent of holding a temporary status in terms of the transactions intended by the user. It is upon an additional recognition of proximity that the indicates user's continued proximity that the temporary holding status is removed and the intended transactions are finalized with the system. Again taking the restaurant service for example, after scanning a graph code, the user is allowed to order from the menu but needs to scan a graph code again in order to confirm order to complete the transaction with the system.

In some embodiments, the system creates a temporary data structure for the user upon his or her user device being recognized as in proximity to the localized service. In one embodiment, the data structure, identified by a system generated ID for the user, contains information relating to the interaction of the user with the service. The data structure further has a pre-determined expiration time, for example, 4 hours for dinner time and 2 hours for lunch time, so that the system automatically remove the data structure once it expires. In some embodiments, this is accomplished using a timestamp given to the data structure as it is being made. In such embodiments, a garbage collection unit will subsequently periodically compare the timestamp and the current time. If the difference between the timestamp and the current time is over a predetermined threshold value, the data structure is deleted or marked for deletion. In some embodiments, the expiration of time requirement is accomplished using an automatically decaying field corresponding to the data structure. The system can also remove the data structure upon detecting an exit when the user leaves the localized service. Take a bar service for example, when a user orders after scanning a graphic code, all the transaction are stored in such a temporary data structure. When the user leaves, upon detecting the exit, the user is prompted through an interface on his device to close any tabs that are still open. With such a temporary data structure, only one access point is needed for the localized service. Again, NFC technology can be used to implement the localized transactions.

In some embodiments, security and privacy preserving measures are implemented in authorizing of the user the access to the private network as well as the localized services. In some embodiments, security and privacy measures are also implemented to safeguard interaction and transaction between the user and the localized service.

In some embodiments, a platform is provided for both businesses and businesses' customers to easily set up their own account and be able to perform transactions between each other. In such embodiments, the platform is not limited to the specific business, but are generalized for many types of businesses. In some embodiments, the platform will allow businesses to mark specific locations within their physical location with typical means (such as seat number, table number and such . . . ) but also via QR codes applied to as many locations as desired. In such embodiments, the business knows where to deliver the order and the customer does not have to go to pick it up (unless that option is selected).

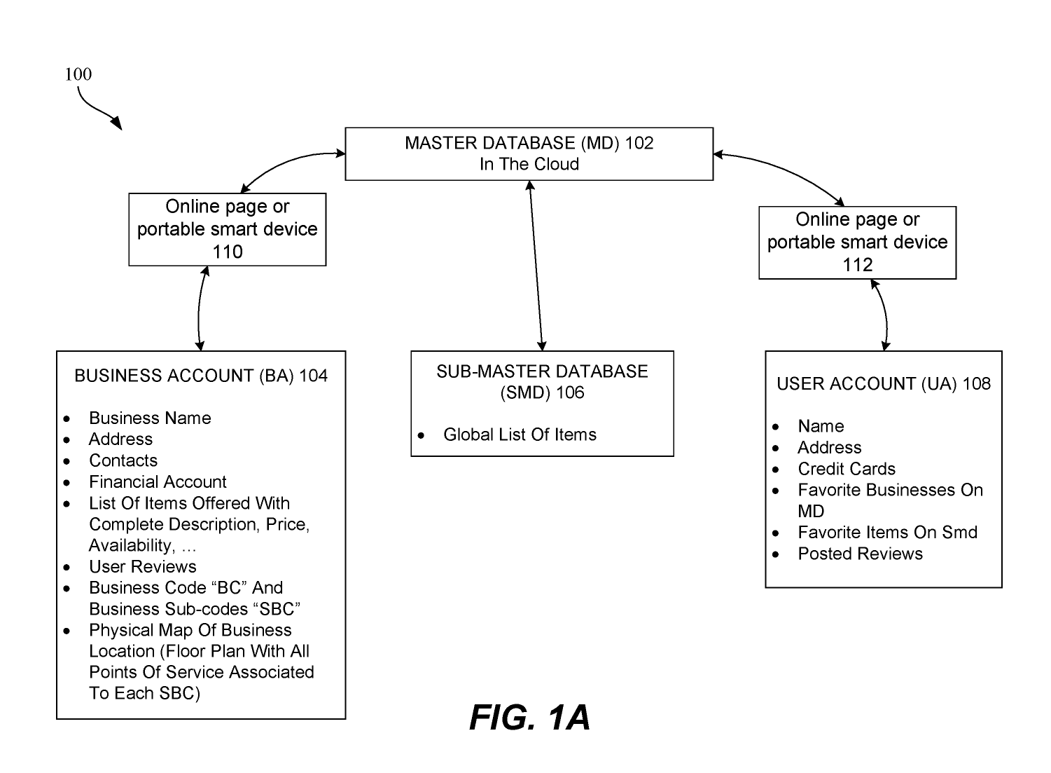

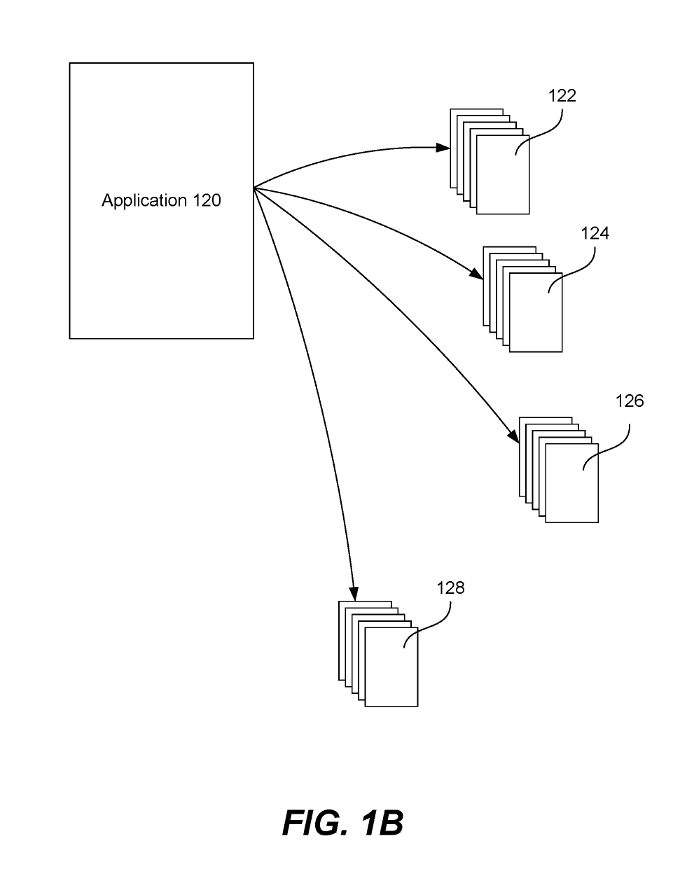

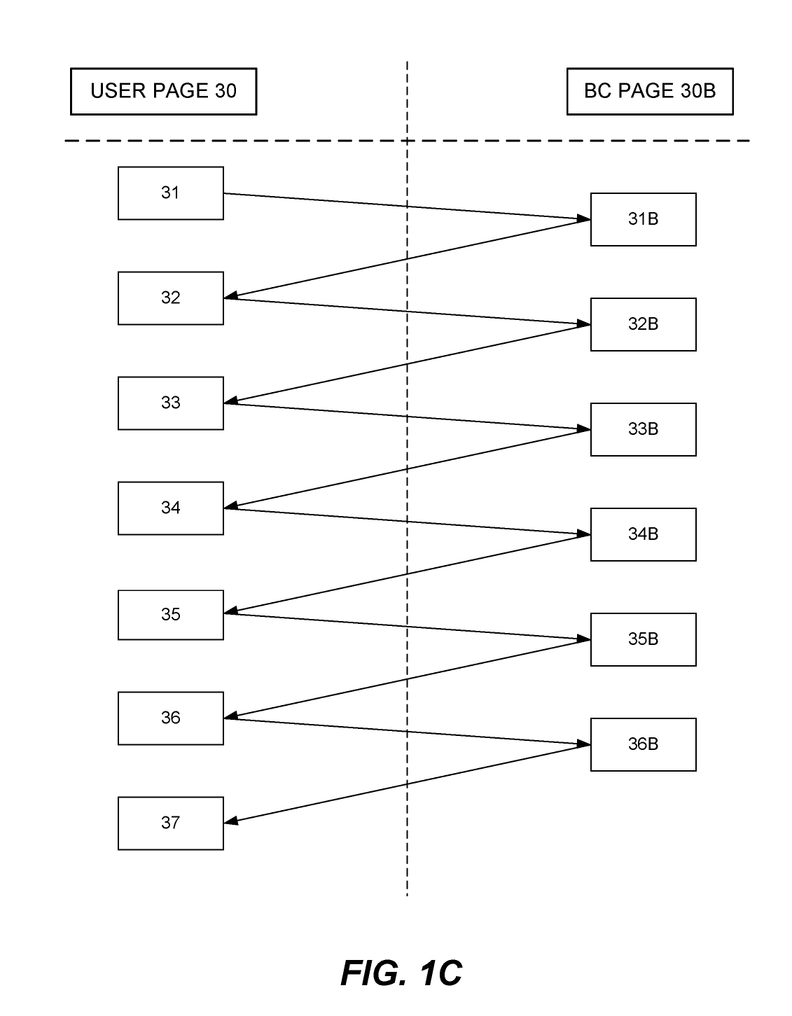

FIG. 1A depicts an example data system in accordance with one or more embodiments of the present disclosure. In some embodiments, the system maintains a main database (MD) 102, which includes one or more business account records (BA) 104. In some embodiments, the data system 100 provides a GUI or a Web page that allows a service owner to enter certain description or interact with a menu (e.g., a dropdown list of required fields) to create a business record (BA) for a service owned or operated thereby into main database (MB) 102. The GUI or Web page can be displayed on any suitable computing device 110, including, but not limited to, PCs, PDAs, tablets, or the like. Such a BA provides information about the service to include, but not limited to, business name, business address, business contacts, business financial account, as well as the one or more items serviced by the business of the record.

Accordingly, the one or more items provided by the service includes, but not limited to, information such as detailed description, price, properties or features or attributes that the owner is required or willing to provide with. The description can be presented with or without details with regard to an item. For example, the description is simply recorded as “regular coffee” or “decaf coffee.” For another example, the description is recorded to include details at the level of a menu item to inform and entice a potential customer. The properties or features or attributes associated with an item includes information that is physical or mechanical or chemical with regard to an item. For example, the properties is recorded as how many calories per serving, whether the item is organic, whether there is a vegan option.

In some embodiments, a BA is implemented to further include a business code (BC) representing a physical location of a business. For example, for a chain or a franchise restaurant, a specific BC is assigned to identify an individual business which possibly shares a certain amount of information with other chain or franchise establishments. Depending on implementation, a BC can be generated by the access system, or by the service owner.

In some embodiments, a BA includes a sub-business code (SBC) representing a specific physical location that is within the facility of business, or within a certain proximity to the physical location of the business. Similarly, depending on implementation, a SBC is generated by the access system, or entered by the service owner. In embodiments where the access system is capable of generating SBCs for a service, additional information relating to the physical premise of the service (e.g., floor plan) and the proximity thereof is provided by the service owner, or by a third party location information provider, such that the access system is equipped with sufficient data to map out SBC for a particular service premise.

As shown in FIG. 1A, the recorded one or more items serviced by a business is aggregated into a sub-master database (SMD) 106 so that the SMD includes all the items serviced by all the businesses registered in MD 102. In some embodiments, SMD 106 has item categories based on item type/ingredients, these categories are set by app administrators and cannot be changed by business codes. Business codes can customize their menu categories. Categories should include vegan, vegetarian, main health issues. App admin can add new categories based on business codes or user input. In some embodiments, a consumer queries MD 102 through the access system to be informed about similar services available. In some other embodiments, a business owner queries MD 102 to obtain reference point, or to copy or borrow the materials that are already created by other business owners.

In some embodiments, the access system also provides a GUI or a Web page that allows a customer to enter certain description or interact with a menu (e.g., a dropdown list of required fields) to create a user account (UA) 108 in MD 102. The GUI or the Web page is displayed at any suitable computing device 112 including, but not limited to, PCs, PDAs, tablets, smart phones, smart wearable device, or the like. In some embodiments, UA 108 includes information such as, and not limited to, user name, billing address, delivery address, billing methods, and favorites. In some embodiments, billing methods includes one more credit card information or bank account information. In some embodiments, favorites includes the user's favorite business that is registered with MD 102, or include the user's favorite items serviced by a business that is registered with MD 102, or the combination thereof.

In some embodiments, a service creates a BA in MD 102 of the access system. The system automatically generates a unique BC for the particular service. The system further automatically generates multiple SBCs, i.e., SBC₁, SBC₂, . . . , SBCₙ, to identify a series of locations associated with the operation of the service. The access system further generates an access point for each of the SBCs, respectively. Depending on implementation, the access point may contain information in the form of a graphic code, a quick response code, a bar code, or the like technology that is suitable to store the information. It should be noted that the provided examples herein are for illustration purposes and to provide a better understanding of the concepts disclosed herein and should not be construed to unduly narrow the scope of the claimed subject matter to any particular details.

In some embodiments, the system includes additional important features. For example, in some embodiments reservation items become unavailable after orders are processed. In some embodiments, admin levels allow a user to create diagrams with page numbers for all possible applications. In some embodiments, for unexpected events the order is not processed or is canceled. In some embodiments, push notifications for advertising or alerts are implemented. In some embodiments, favorite places, special offers, local/nearby businesses push offers are based on user preferences.

FIG. 1B illustrates an example application 120 in accordance with one or more embodiments of the present disclosure. Application 120 includes multiple pages 122, 124, and 126, each grouped for different modes/functions of the application.

In some embodiments, multiple page group 122 includes user app pages 1-5B. These pages may contain the following features on the following example pages.

### Page 1

Scan code—1A
Find in current location (GPS)—1B
Favorites—1C
Map (filters)—1D

### Page 1A

Display or scanner
   Scanned BC—2A
   Scanned SBC—2B

### Page 1B

This appears logical only for 2A
All BC have on their record geographic coordinates.
Based on the user current locations
   A list of nearby BCs are shown
   Map view option
   Taping on BC—2A

### Page 1C

List of map view of saved BCs
Taping—2A

### Page 2A

This is a business location with no SBCs (drive-thru, other pick up only businesses, bar that serves only at counter . . . )
Loads business page with logo on top and menu—lists at top of page hours of operation and shows alarm if closed or closing soon
Menu is a list per category—top of page, list view—pictures view
Search 3A
Favorites (if any for BC)—3B
Temp filters
Cart—3D
Menu open category and subcategories, until single item with price and all ingredients that are all selected by default but can be deselected—photo—previous orders 3C

### Page 2B

Same as 2A but it has saved in the cart the physical location (SBC)

### Page 3A

This page can be opened from main menu page or each category and subcategory
After say 3 characters are inserted, it starts showing a list of results also on top of this page the list or picture view selection
Selecting an item will go to 2A
Note: On Page 3D add a button “Check Waiting List”: this sends a request to the BC account which returns a message like: if processed within 30 seconds, your order would be #______. On the waiting list with an estimate preparation and delivery time of ______ minutes. The page shows a counter and a large “Order Now” button and “Cancel” button.

### Page 3B

List of favorite items saved for this BC
Tap+to add directly to cart

### Page 3C

List of previous orders for the specific BC listed by date and time and named Order 1 . . .
Tapping on order will show list of items and details
Swiping on order allows to give it a custom name and picture
Even changing to custom names the date of each order is saved in the record
Once an order is added to the cart, it will be shown as signal items so the new order can be customized

### Page 3D

Top of page has list or pictures
Each item can be removed by swiping it out of the screen
Bottom of page still shows 3A, 3B, 3C so more items can be added
Right above bottom menu a large order button 4D on bottom menu also listed group order 4A
For large venues with seat #, provide step to insert seat # for delivery to user
Also plan for a system where BC worker portable device shows exact location of user based on GPS and such. This of concert venues field area.

### Page 4A

Shows:
   Create group 5A
   Join group 5B

### Page 4D

Shows:
   Order sent
   Order status

In some embodiments, multiple page group 124 includes user account setup pages 10A-10D, and 5A-5B. These pages may contain the following features on the following example pages.

### Page 10A

First Name
Last name
Email
Cell phone #
Language—as phone settings
Currency
Send—10B

### Page 10B

Enter code sent via text to phone once code is verified
Show T&C particularly highlight most important #s
When order is not paid by user within ______ minutes from delivery, app charges automatically—10C

### Page 10C

Set up credit cards and/or bank accounts—allow custom names and colors for each account for easy check out
Provide advanced ways to add credits cards as taking pictures
Verify accounts with small transactions—10D

### Page 10D

Account set up complete
Welcome message
Offer tutorial or proceed to 1A

### Page 5A

Group name
Code
Send—pre group order is sent to BC cloud record
Close group and order—all members of group have this option—then goes to 4D

### Page 5B

Lists open pre-group orders on BC record
Tap on order name, add code
   Goes to 5A

In some embodiments, multiple page group 126 includes business side setup pages 20A-24A, and 50A. These pages may contain the following features on the following example pages. NOTE: Depending on whether revenues go straight into one franchise bank account or local bank accounts for each branch, bank accounts are set up down here.

### Page 20A

Business name
Logo
This are for the business or franchise general admin
Admin email for BC1
Admin cell phone for BC1
App color scheme
Send—20B

### Page 20B

Enter code sent via text message
Once code is verified—20C

### Page 20C

Set up location 1 (20D)
Set up additional locations (gray until location 1 is set up)

### Page 20D

Admin first name
Admin last name
Admin email
Admin cell phone
Send code
Enter code 20E

### Page 20E

Business loc X
Address
Geo address—get from iPad
Land line
Email address
Set up menu—21E
Email address
Set up BCX map 22E
Set up SBCs 23E
Set up BC workers 26A
Item preparation stations with code for each (Bar 1, Bar 2, Kitchen 1, . . . )

### Page 21E

Food 21F
Drink 21F
. . .

### Page 21F

Search box searches on SMD if matching item is found, tapping on it will open item detail page—50A—the search box includes options for searching only item names or ingredients or entire records—Results shown with priority names, ingredients, full description
Once the item page has been accepted or modified, an Add to Menu button will appear
New item—50A
Typical menus—this could open a list of presaved typical menus as American Bar, Italian pizza . . .
Option to search online for items and display a browser window next to the app's new item window for ease of creating new menu items from online data
See menu—21GBack to business account set up 20E

### Page 21G

Shows menu the same way users see it but with admin rights
Categories and items can be reorganized by tap/hold then move
SMD master categories cannot be changed (food, drinks, vegan, alcoholic, . . . ) while BC can customize their menu categories (appetizers, tapas, . . . )

### Page 22E

Import PDF map 22F
Draw map 22G
Import from branch 22H

### Page 22F

Open import from other apps on device
Once file is selected, page can be adjusted, reframed, but no editing content allowed
Confirm—23E

### Page 22G

Best would be an in-app application to simply draw floor plans, tables, counters and such, similar to the aye i found some time ago for surveys on iPad
Complete—23E

### Page 22H

Accesses and lists all maps saved for franchise and allows to import the desired one
Complete—23E

### Page 23E

Codes
List 23G
Map 23H

### Page 23G

Lists all codes already created allowing to edit each code has a custom description and the actual code as BC x SBC x
Opening each code details allows to assign it to a pin on the map
Button print allows to select one/more codes and print labels

### Page 23H

Opens location map on entire display and shows pins already assigned map is shown gray, pins are shown in a bright color able to zoom in/out
tap/hold on pin opens options move, edit, delete
Tap/hold on map creates new pin and opens detail page, then back to map

### Page 24A

List workers already recorded and deleted and allows to edit the first ones
Create new opens page with
   First name
   Last name
   Cell phone
   Email
   Code BCWx—set here is only the X which is used daily by workers to use app (BCW is created automatically)
   Info required for payroll
   Mailing address

### Page 50A

Item name—if existing, any change not to the name, will save an additional version
Pictures
Category
Description
Ingredients—SMD has a sub-record for basic ingredients
User reviews
Other details as calories
Approximate preparation time
Preparation station

In some embodiments, multiple page group 128 includes business side interface pages 30A-30C. These pages may contain the following features on the following example pages.

### Page 30A

enter BCWx code—30B
Admin access enter code and password—20E

### Page 30B

List of current orders with user name in capital letters and time order was received
Orders listed by the received also with different colors based on status
Orders are sent to preparation station based on order type (food, drink), proximity of station, stations work load, . . .
Red—order not started
Normal—under preparation
Flashing—part of order is under preparation or already delivered
Gray—order complete (delivered), awaiting payment by user
Light gray—complete and paid
Worker is forced by app to start next order on list—dumping an order requires admin input—verify if good or not
Worker taps/accesses order by inserting BCWx code (or worker accesses order but enters his code only when accepting order)—30C
Status of order is updated on all terminals as well as user's phone. Time is recorded at all formal steps and saved on BC admin records

The features/options for pages presented above are just some examples of features on pages. Various embodiments of the present disclosure may include other pages with other features not listed above. In addition, some embodiments will incorporate different features from different pages into new pages.

FIG. 1C illustrates an example user order and BC sequence in accordance with one or more embodiments of the present disclosure. Steps 31-37 are all steps generated by the User Page 30, as described above. Steps 31B-36B are all steps generated from BC Page 30B, as described above. The sequence begins at 31, where a user checks a waiting list page. At 31B, a potential order is placed on temp list but not shown on the current orders list. At 32, the user confirms the order and is taken to order status/tracking page. At 32B, a new order appears on the bottom of the current orders list. In some embodiments, the BC sends out an update to current waiting orders users every time an order is sent out for delivery. At 33, the user page is updated showing: “You are #______ on the list with expected delivery time of ______ minutes.” At 33B, the order gets to top of list and is selected by a worker. At 34, the user page shows: “Your order is being prepared by (names of worker) with expected ready/delivery time of ______ minutes.” In some embodiments, different order types can be as follows: Type 1—Consumed at facility and paid at delivery (drinks at bar); Type 2—Pick up at facility or delivery outside facility (food to go, . . . ); Type 3—Consumed at facility and paid later—open tab (drinks at bar, restaurant table, . . . ). At 34B, different orders are distinguished here and delivered directly by the preparer or require additional workers for delivery within or outside facility (depending on order type). In some embodiments, the workers marks the order as ready. At 35, the user gets an update depending on the order type (“Your order is ready for pick up” or “Your order is being delivered to you”). At 35B, when the picked up/delivered or tab is closed, the user is asked to process a payment. This can be done either through the user's device, a BC fixed device, or a BC worker's portable device. In some embodiments, options for tips will be presented on this page. Payment is processed through the system. At 36, the user is presented a page with payment confirmation. In addition, an electronic copy of receipt is emailed. At 36B, BC workers will be presented with an option to review the user/customer. At 37, the user is presented a page with all review options for: each ordered item, servers, overall quality/price, and/or overall experience. In some embodiments, each of the review options will have a quick stars based review with option also to tap each and add an additional written review. Note that the steps provided above only present one possible order for steps. In some embodiments, other orders for sequences are also possible, using any of the steps presented above in any order.

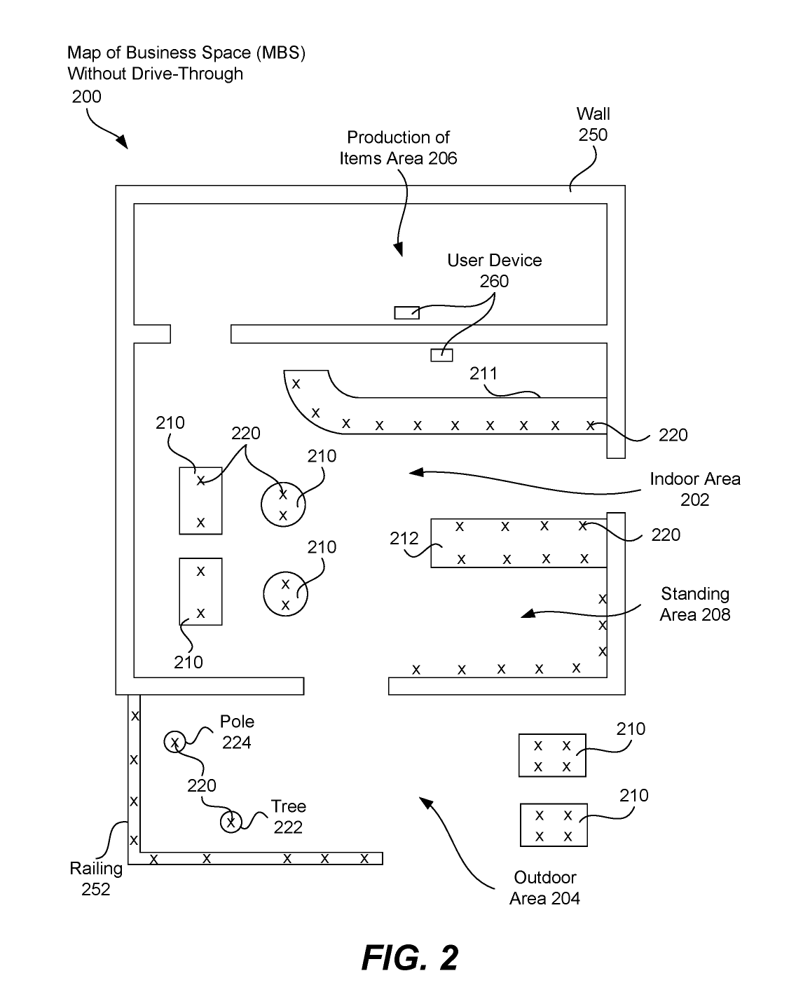

FIG. 2 illustrates an example configuration 200 of access points in the context of an example business establishment that does not allow drive-through service in accordance with one or more embodiments of the present disclosure. In some embodiments, the generated access points 220 are positioned to their correspondent physical locations at the site of the service. For example, access points 220 may be print-outs of the graphic codes and may be placed and displayed in a manner that is easily noticeable for a customer to interact with. When the access system generates multiple access points 220 without reference to physical locations, the service owner may designate the placement of access points 220 and update MD 102 with the physical locations corresponding to the placed access points. Such an update can be in any form, for example, textual description of the location or a visual indicator such as a pin drop on a graphical interface implemented for the access system, etc.

The placement of the multiple access points can be implemented in any form, for example, adhesion of an access point printed on a label to its corresponding location, holding of an access point printed on a label in a clear plastic tag holder positioned in a corresponding location, projecting of an access point's information, e.g., graphic code, onto a surface at a corresponding location, or displaying of an access point information on an electronic device situated at a corresponding location.

As shown in FIG. 2, multiple SBCs are configured for different areas within the business establishment, e.g., indoor area 202, patio/outdoor area 204, production of items area 206, standing section 208, counter 211, tables 210, communal table 212, poles 224, trees 222, walls 250, railings 252, etc. The localized service offered by the business establishment limits access thereto by acquiring a user to be in proximity to the premise (e.g., a building, etc.) and the SBCs function as access points that allow a user's device to recognize such proximity by being able to scan the SBCs. Once required proximity is required, the user is authorized to access the private network and therefore the localized service hosted on the private network.

In some embodiments, two or more services shares one or more access points due to close proximities amongst each other. In this scenario, it is up the user to select from the two or more services configured at the same access point to proceed to further interaction with the service of choice. In some embodiments, the system includes user devices 260 to supplement as additional means of ordering and communicating with the system.

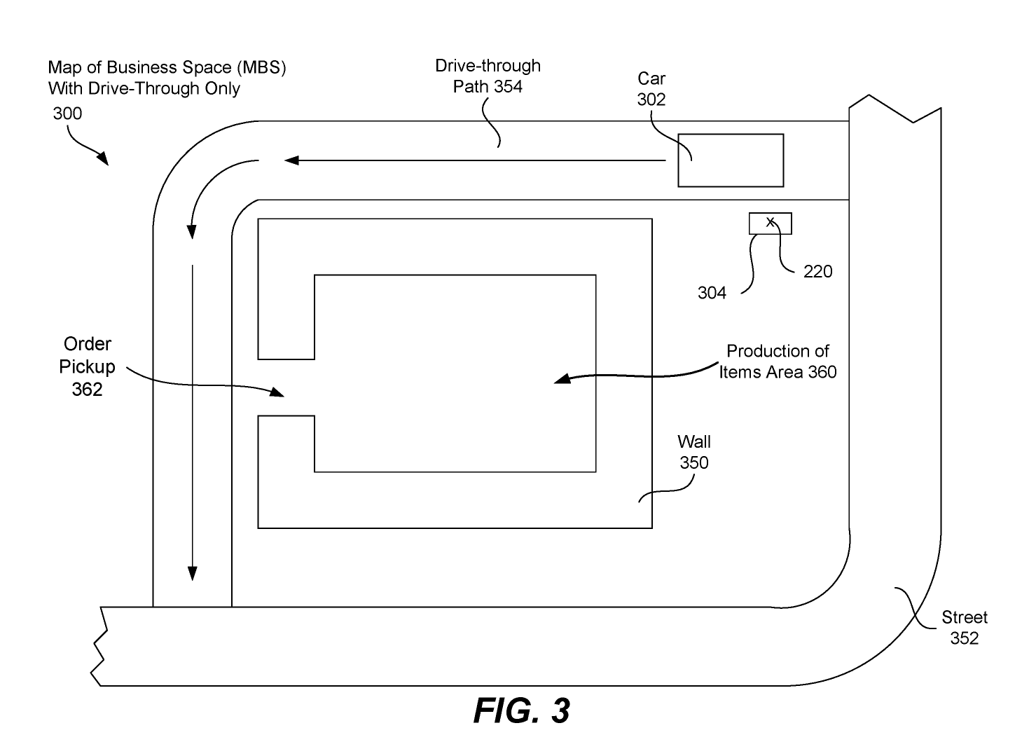

In some embodiment, there are no multiple SBCs generated to designate proximity to a localized service. Instead, the BC suffices to indicate similar proximity to the service. FIG. 3 illustrates an example configuration 300 of access points 220 in the context of an example business establishment that allow only drive-through service in accordance with one or more embodiments of the present disclosure. As shown in FIG. 3, only a single access point 220 is needed to key off the required proximity to the premise of the localized service. In this example, the access point key captures the BC information and is configured at the entrance of the drive-through facility. A user drives car 302 along drive-through 354 and orders at user interface 304. Food is prepared in production items area 360, surrounded by wall 350. Food is then picked up at order pickup window 362. The user then drives back onto street 352.

In some embodiments, in a business establishment such as the drive-up facility as shown in FIG. 3, with vehicles 302 equipped with BLUETOOTH or the like technology and a vehicle user interface 304, the user is able to order directly from the vehicle user interface 304, which presents the system access interface through BLUETOOTH connection to the user's device. Similarly, security and verification features are implemented to ensure secured transaction between the vehicle and the localized service on the private network.

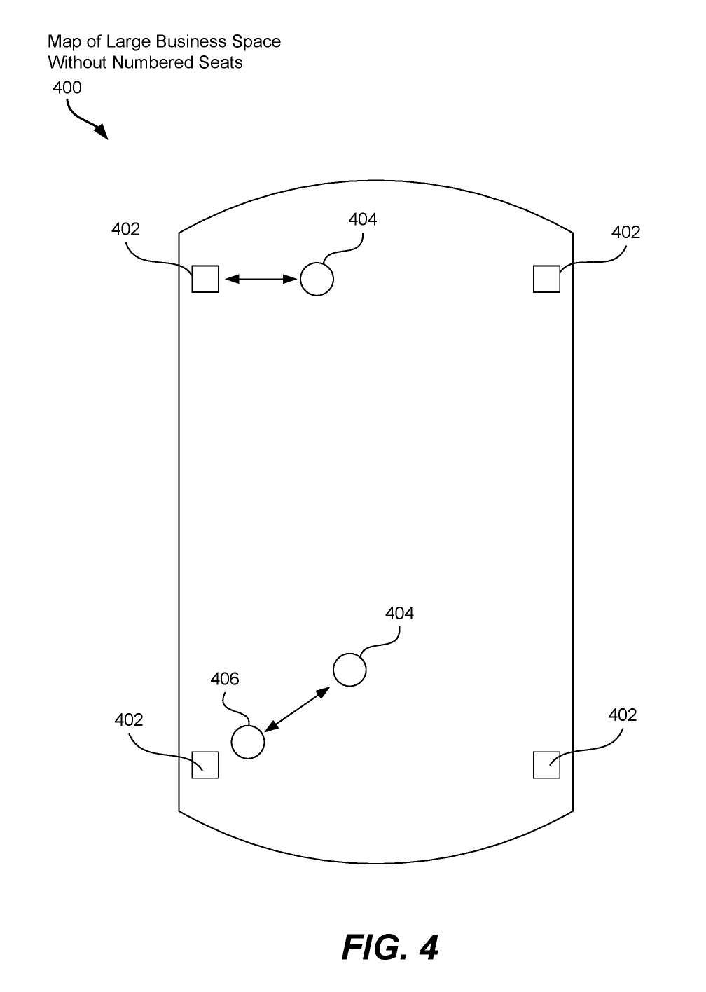

In some embodiments, access points are not necessary for proximity to the localized service. FIG. 4 illustrates an example use of localizing capabilities to provide access to services in the context of an example business establishment 400 where no physical access points are configured. In this example, the premise is a spacious out-door venue where summer concerts are held, or the like. In similar establishments, it is not practical to configure access points to recognize user's proximity due to the sheer size of the venue or the number of users on the premise. Therefore, as the user device is capable of localizing itself and communicating to the system with its location and vice versa, the access system is able to locate the user for services such as delivery or an order, etc. utilizing this feature.

In some embodiments, the service owner further generates an employee code (BCEC) for each of the employee who interact with the access system in order to service a customer of the business.

In some embodiments, a customer becomes connected to a particular service registered in the access system in a variety of ways. In one example, the customer scans a SBC by use of his or her mobile device that is capable of recognizing and extracting information from the SBC. In another example, the customer is presented with suggestions from the access system once his or her location is communicated to the access system. In yet another example, the customer chooses a particular service from MD 102 via an interface of the access system. Such an interface can be implemented in any form, for example, an annotated map, a list of peer recommendations, a list of advertised services, a list of personal favorites, or a list of suggestions from other users of the access system, etc. Such connectivity can be implemented with any suitable technology including but not limited to, for example, the Internet, Bluetooth or cellular networks.

Subsequent to the above-noted mechanisms to initiate connection with a desired service, the customer 404 is authorized with access to the service by the access system. Such access can implemented, for example, by the system loading an interface 402 that presents and displays the information of the service items associated with the service. Informed of the details of the items offered, the customer identities and selects one or more items and place the selection in an order.

In some embodiments, different SBCs represents different access control qualifiers for the service configured available at those access points. In other words, it is noteworthy that the scope of the above described access is controlled by the SBCs. In one example, different SBC indicates different level of services available depending on the relative relation status between the customer and the service. For example, when a customer is waiting outside of a restaurant, he or she can browse the items available and discuss the choices with people in his or her party, not yet allowed to place a meal order. Instead, the drink menu is fully accessible and the customer orders any drink while waiting in the line. In contrast, once the customer advances in the waiting line and scans another SBC, the full menu become accessible for ordering.

In some embodiments, for each order entered, the access system is implemented to present to the customer with the status of the to-be-placed order so that the customer is able to review the associated position of the order in the order queue and estimated wait time for the order to be completed. At this point of time, the customer confirms the order if satisfied with the status information; otherwise the customer cancels the selection and proceed to other options. Once an order in confirmed by the customer, the access system no longer deems the order as temporary in the system.

In some embodiments, once an order is confirmed into the order queue of the system, an employee 406 of the service processes the order and updates the system with the status of the order. Accordingly, the access system in turn updates the customer with the status updated with regard to the order. For example, the customer is informed of the updated wait time, status as under preparation, ready, out for delivery, etc. In one example, an employee who handles the order updates the status with his or her BCEC or name in addition. In another example while in preparation, photo shots or live video feed is provided to the customer's mobile device.

In some embodiments, upon the order status changing into ready, the access system updates the interface utilized by the service with the location of the ordering customer accordingly in a variety of ways. For example, the interface displays description of tags assigned to SBC, a pin on a map, a seat number of a table number recorded from the ordering customer, a particular pick-up location indicated by the ordering customer, position information communicated from the ordering customer's mobile device to the service or vice versa, etc.

In some embodiments, on delivery of the order, the access system is further updated with order status as order delivered. At this point of time, the interface presented to the customer by the access system also updates its content to initiate a payment transaction. For example, such content displays the items ordered, the service location, the servers who service the order, the corresponding amount of expense. In one example, the content queries the customer to input the payment mechanism such as credit card information. In another example, the content retrieves pre-stored payment information associated with the customer and prompt the customer to make a selection to transact the instant payment. In yet another example, if the order status is updated as delivered and the customer hasn't transacted any payment within a pre-determined period of time, the access system is implemented to use the default payment associated with the customer to fulfill the payment. Accordingly, confirmation of payment is delivered electronically to the customer or on paper at the facility.

In some embodiments, with the above described ability to track the detailed status of orders placed by customers, the access system is implemented to further allow the service to communicate to other not-yet-ordering users of the access system with real time information regarding how busy the service is in any form, for example, a current load to capacity ratio. Such real time information is queried by users who may or may not be currently connected to a particular service. For example, a user accessing the system from home finds out that how busy a pizza place is right now and decide to head over to another less busy pizza shop instead. For another example, a user standing in the waiting queue of a restaurant starts to explore other options close-by, decide the wait time is more suitable at another place and walk out of the current waiting queue.

In some embodiments, the access system is implemented to service a group of customers. For example, a group of customers wish to place one order that contains individual choices of order placed by people in the group. In this scenario, the access system allows a first customer to create a group identifier associated with his or her indication of order selection. In one embodiment, the other customer interacts with the system to not only choose their order selection, but also associate the order selection with the group identifier created by the first customer in the group. When the last customer in the group enters the order selection and associate it with the same ground identifier, the last customer submits all the orders relating to the group identifier to the system as one order.

Nevertheless, in some embodiments, once created in the system, the group identifier is also communicated to the respective mobile device of each individual of the group so that the access interface on the respective mobile device is modified automatically with the group identifier information. Accordingly, the customer of the group selects order choices without manually select a group identifier to associate the order with. Upon completion of payment, such group information is removed from the access system.

In some embodiments, a user interacts with the access point using a device that is not be his or her own mobile device (e.g., a smart phone, a smart watch or a tablet). In this scenario, a service distributes a service-specific device to a visiting user so that the user interacts with access points 220 using the device. After the service is completed, the user returns the specific device to the service. Accordingly, with such specific device, a group of users is given one device and every person in the group uses the same device to enter orders, which in turn will automatically be organized into one order associated with that particular device.

In some embodiments, the access system is implemented to allow a combination of the use of user's own mobile devices and the use of the above-described service-specific devices. The use of either type of device does not need to be exclusive to each other for a particular user.

In some embodiments, the access system is further implemented to allow a user to modify a previously entered selection of service items provided by a service. After the selection is confirmed and as long as the selection is still pending in the queue, the user is able to interact with the system to change the selection or even make cancellation thereof. In one example, a user obtains access via the SBC to a theme park ride and waits in the long queue. After spending an extended period of time waiting, the user decides to upgrade to the fast access queue that allows for immediate boarding of the ride. To do this, the user interacts with an upgrade option displayed after scanning the SBC, and transact payment for the upgrade as well.

It is understood that the access system help simplify and expedite interaction such as ordering and payment transactions with multitude of services registered and configured available to various extent at their correspondent access points with associated access control qualifiers. As a result, a middle entity who facilitates a user's interaction with a service is reduced or eliminated.

Benefits produced for the services may include, but not limited to, for example, instant tracking of tracking of all orders, customer payments, employee tasks, number of tasks completed and time to complete towards employee efficiency, customer review for employees, automatic and instant reports on all items ordered, produced, revenues, customer and items ordering trends; eliminating ordering via phone and related possible mistakes; eliminating risk of customers not processing payment for delivered orders; eliminating need for printed lists of items offered and allow for instant updates on such lists; possibility to include detailed description and pictures of each item offered; possibility to view on business interface all current orders on a list or map view with color codes depending on status of each order (e.g., confirmed, in process, ready, out for delivery, delivered, awaiting payment, completed, etc.). Furthermore, the above-described information is stored and filtered and shown via displaying of any suitable data structure such as a list or map.

In particular, for drive-through type of businesses, the present access system may eliminate the need of communicating vocally with the person in charge of taking the order; when the customer enters the business lot he or she only needs to scan the location BC, send the order and drive to the pick up location. His/her order goes directly to the item production area with no intermediate person. Similarly, possibility to automatically print an adhesive label for each order, with customer name, that can be easily attached to the order packaging simplifies delivery.

Furthermore, the present access system tracks repetitive customers to offer discounted prices or additional services or bonuses. Depending on customers' preferences, the access system sends push notifications to all past customers for special offers and general advertising of business, create list of items ordered by the business by selecting items already loaded into MD 102 by the access system or by other businesses. In one example, the above described features any be available via Internet connection to any portable device or computer to business employees with administrator status. Benefits may further include optimizing business management, maximizing profit by review of system automatic reports, and instantly comparison of the inventory with ordering trends for supply orders.

On the other hand, from the perspective of a customer of a service, the present access system also provides benefits including, for example, automatic money transaction with no physical exchange of cash or credit cards; no waiting time to process the order nor payment; instant information on order processing time until delivery; up to the second list of items offered by the specific business automatically loaded into user portable interface with detailed description and medias as set up by the business; stored favorite businesses, items, business workers, etc.; receiving receipts via email or to system interface on portable device; simplified group orders as described above avoiding confusion and time consuming elaboration of total bill; receipts including named group order to remind customer of specific event; easy process payment with preloaded tip options and saved credit card; easy post reviews of business location, list of items, business workers automatically shown by the system on the portable device at the end of the order; viewing of “load to capacity ratio” for businesses within the system for planning visits and orders, receiving automatically indication on “trendiness” of businesses as well as expected waiting time before heading to the business. In one example, the trendiness may be shown on a map view with “total number of current customers” or “load to capacity ratio” shown as percent or color coded. With the color coded pins on the map the system can show to the customer those trendy/busy/crowded areas for selected type of business.

The above described benefits further includes allowing orders to go directly through the access system with up to the second real time feedback on availability and waiting time; processing of reservations for orders for a later time directly from the system interface on the customer portable device; loading of business pages into customer interface in customer's interface native language with text automatically translated and cost of items automatically estimated and shown in customer's native currency.

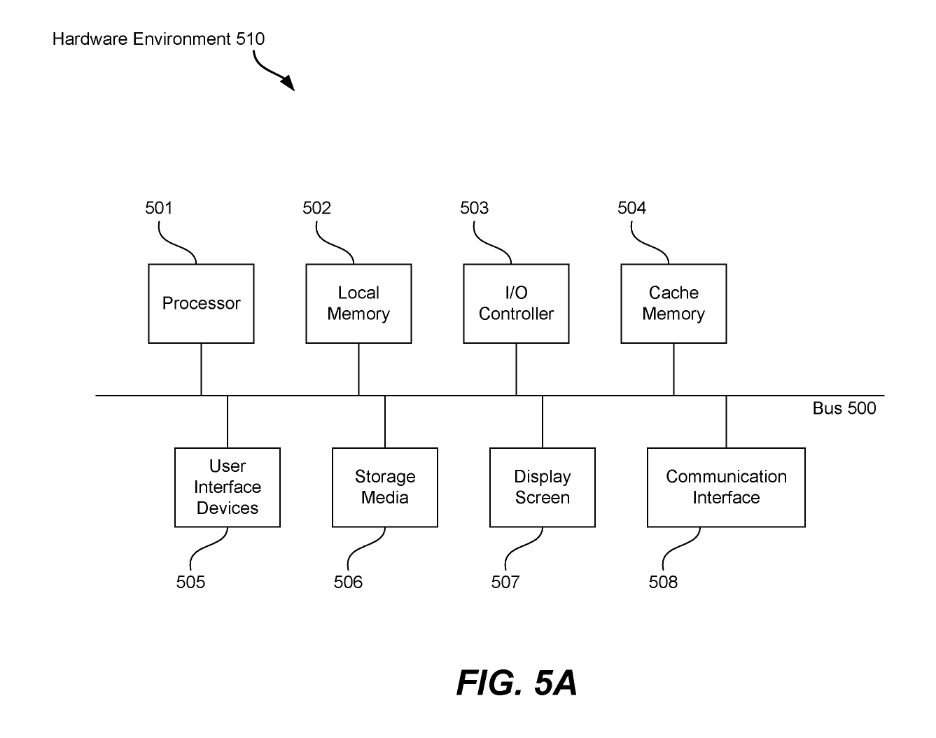

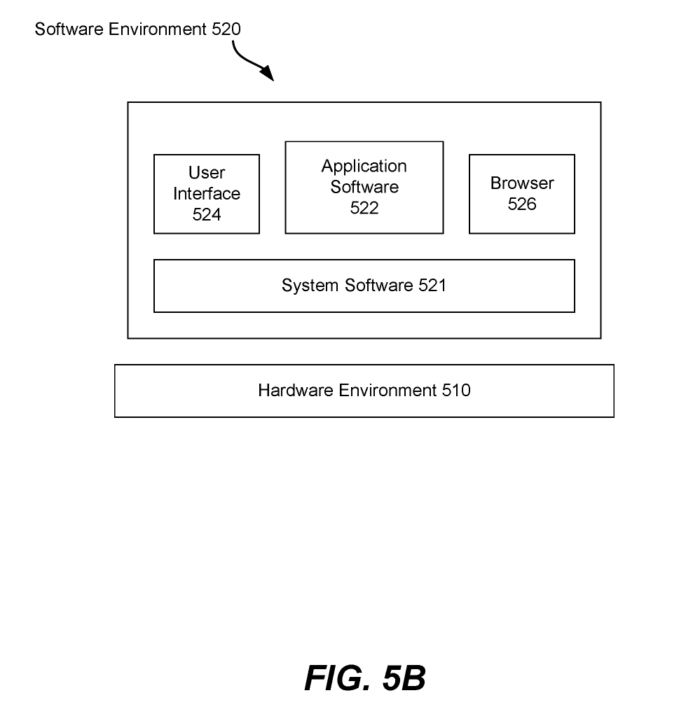

Referring to FIGS. 5A and 5B, a computing system environment in accordance with an exemplary embodiment is composed of a hardware environment 510 and a software environment 520. The hardware environment 510 may comprise logic units, circuits or other machinery and equipment that provide an execution environment for the components of software environment 520. In turn, the software environment 520 may provide the execution instructions, including the underlying operational settings and configurations, for the various components of hardware environment 510.

Referring to FIG. 5A, the application software and logic code disclosed herein may be implemented in the form of machine readable code executed over one or more computing systems represented by the exemplary hardware environment 510. As illustrated, hardware environment 510 may comprise a processor 501 coupled to one or more storage elements by way of a system bus 500. The storage elements, for example, may comprise local memory 502, storage media 506, cache memory 504 or other machine-usable or computer readable media. Within the context of this disclosure, a machine usable or computer readable storage medium may include any recordable article that may be utilized to contain, store, communicate, propagate or transport program code.

A computer readable storage medium may be an electronic, magnetic, optical, electromagnetic, infrared, or semiconductor medium, system, apparatus or device. The computer readable storage medium may also be implemented in a propagation medium, without limitation, to the extent that such implementation is deemed statutory subject matter. Examples of a computer readable storage medium may include a semiconductor or solid-state memory, magnetic tape, a removable computer diskette, a random access memory (RAM), a read-only memory (ROM), a rigid magnetic disk, an optical disk, or a carrier wave, where appropriate. Current examples of optical disks include compact disk, read only memory (CD-ROM), compact disk read/write (CD-R/W), digital video disk (DVD), high definition video disk (HD-DVD) or Blue-ray™ disk.

In one embodiment, processor 501 loads executable code from storage media 506 to local memory 502. Cache memory 504 optimizes processing time by providing temporary storage that helps reduce the number of times code is loaded for execution. One or more user interface devices 505 (e.g., keyboard, pointing device, etc.) and a display screen 507 may be coupled to the other elements in the hardware environment 510 either directly or through an intervening I/O controller 503, for example. A communication interface unit 508, such as a network adapter, may be provided to enable the hardware environment 510 to communicate with local or remotely located computing systems, printers and storage devices via intervening private or public networks (e.g., the Internet). Wired or wireless modems and Ethernet cards are a few of the exemplary types of network adapters.

It is noteworthy that hardware environment 510, in certain implementations, may not include some or all the above components, or may comprise additional components to provide supplemental functionality or utility. Depending on the contemplated use and configuration, hardware environment 510 may be a machine such as a desktop or a laptop computer, or other computing device optionally embodied in an embedded system such as a set-top box, a personal digital assistant (PDA), a personal media player, a mobile communication unit (e.g., a wireless phone), or other similar hardware platforms that have information processing or data storage capabilities.

In some embodiments, communication interface 508 acts as a data communication port to provide means of communication with one or more computing systems by sending and receiving digital, electrical, electromagnetic or optical signals that carry analog or digital data streams representing various types of information, including program code. The communication may be established by way of a local or a remote network, or alternatively by way of transmission over the air or other medium, including without limitation propagation over a carrier wave.

As provided here, the disclosed software elements that are executed on the illustrated hardware elements are defined according to logical or functional relationships that are exemplary in nature. It should be noted, however, that the respective methods that are implemented by way of said exemplary software elements may be also encoded in said hardware elements by way of configured and programmed processors, application specific integrated circuits (ASICs), field programmable gate arrays (FPGAs) and digital signal processors (DSPs), for example.

Referring to FIG. 5B, software environment 520 may be generally divided into two classes comprising system software 521 and application software 522 as executed on one or more hardware environments 510. In one embodiment, the methods and processes disclosed here may be implemented as system software 521, application software 522, or a combination thereof. System software 521 may comprise control programs, such as an operating system (OS) or an information management system, that instruct one or more processors 501 (e.g., microcontrollers) in the hardware environment 510 on how to function and process information. Application software 522 may comprise but is not limited to program code, data structures, firmware, resident software, microcode or any other form of information or routine that may be read, analyzed or executed by a processor 501.

In other words, application software 522 may be implemented as program code embedded in a computer program product in form of a machine-usable or computer readable storage medium that provides program code for use by, or in connection with, a machine, a computer or any instruction execution system. Moreover, application software 522 may comprise one or more computer programs that are executed on top of system software 521 after being loaded from storage media 506 into local memory 502. In a client-server architecture, application software 522 may comprise client software and server software. For example, in one embodiment, client software may be executed on a client computing system that is distinct and separable from a server computing system on which server software is executed.

Software environment 520 may also comprise browser software 526 for accessing data available over local or remote computing networks. Further, software environment 520 may comprise a user interface 524 (e.g., a graphical user interface (GUI)) for receiving user commands and data. It is worthy to repeat that the hardware and software architectures and environments described above are for purposes of example. As such, one or more embodiments may be implemented over any type of system architecture, functional or logical platform or processing environment.

It should also be understood that the logic code, programs, modules, processes, methods and the order in which the respective processes of each method are performed are purely exemplary. Depending on implementation, the processes or any underlying sub-processes and methods may be performed in any order or concurrently, unless indicated otherwise in the present disclosure. Further, unless stated otherwise with specificity, the definition of logic code within the context of this disclosure is not related or limited to any particular programming language, and may comprise one or more modules that may be executed on one or more processors in distributed, non-distributed, single or multiprocessing environments.

As will be appreciated by one skilled in the art, a software embodiment may include firmware, resident software, micro-code, etc. Certain components including software or hardware or combining software and hardware aspects may generally be referred to herein as a “circuit,” “module” or “system.” Furthermore, the subject matter disclosed may be implemented as a computer program product embodied in one or more computer readable storage medium(s) having computer readable program code embodied thereon. Any combination of one or more computer readable storage medium(s) may be utilized. The computer readable storage medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing.

In the context of this document, a computer readable storage medium may be any tangible medium that can contain, or store a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable storage medium may be transmitted using any appropriate medium, including but not limited to wireless, wireline, optical fiber cable, RF, etc., or any suitable combination of the foregoing. Computer program code for carrying out the disclosed operations may be written in any combination of one or more programming languages, including an object oriented programming language such as Java, Smalltalk, C++ or the like and conventional procedural programming languages, such as the “C” programming language or similar programming languages.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Certain embodiments are disclosed with reference to flowchart illustrations or block diagrams of methods, apparatus (systems) and computer program products according to embodiments. It will be understood that each block of the flowchart illustrations or block diagrams, and combinations of blocks in the flowchart illustrations and/or block diagrams, can be implemented by computer program instructions. These computer program instructions may be provided to a processor of a general purpose computer, a special purpose machinery, or other programmable data processing apparatus to produce a machine, such that the instructions, which execute via the processor of the computer or other programmable data processing apparatus, create means for implementing the functions or acts specified in the flowchart or block diagram block or blocks.

These computer program instructions may also be stored in a computer readable storage medium that can direct a computer, other programmable data processing apparatus, or other devices to function in a particular manner, such that the instructions stored in the computer readable storage medium produce an article of manufacture including instructions which implement the function or act specified in the flowchart or block diagram block or blocks.

The computer program instructions may also be loaded onto a computer, other programmable data processing apparatus, or other devices to cause a series of operational steps to be performed on the computer, other programmable apparatus or other devices to produce a computer or machine implemented process such that the instructions which execute on the computer or other programmable apparatus provide processes for implementing the functions or acts specified in the flowchart or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical functions. It should also be noted that, in some alternative implementations, the functions noted in the block may occur in any order or out of the order noted in the figures.

For example, two blocks shown in succession may, in fact, be executed substantially concurrently, or the blocks may sometimes be executed in the reverse order, depending upon the functionality involved. It will also be noted that each block of the block diagrams or flowchart illustration, and combinations of blocks in the block diagrams or flowchart illustration, may be implemented by special purpose hardware-based systems that perform the specified functions or acts, or combinations of special purpose hardware and computer instructions.

The claimed subject matter has been provided here with reference to one or more features or embodiments. Those skilled in the art will recognize and appreciate that, despite of the detailed nature of the exemplary embodiments provided here, changes and modifications may be applied to said embodiments without limiting or departing from the generally intended scope. These and various other adaptations and combinations of the embodiments provided here are within the scope of the disclosed subject matter as defined by the claims and their full set of equivalents.

Further, those skilled in the art will appreciate that one or more elements of the aforementioned computer system may be located at a remote location and connected to the other elements over a network. Further, embodiments of the present disclosure may be implemented on a distributed system having a plurality of nodes, where each portion of the present disclosure may be located on a different node within the distributed system. In one embodiment of the present disclosure, the node corresponds to a computer system. Alternatively, the node may correspond to a processor with associated physical memory. The node may alternatively correspond to a processor with shared memory and/or resources. Further, software instructions for performing embodiments of the present disclosure may be stored on a non-transitory computer readable storage medium such as a compact disc (CD), a diskette, a tape, or any other computer readable storage device.

While the present disclosure has been described with respect to a limited number of embodiments, those skilled in the art, having benefit of this disclosure, will appreciate that other embodiments can be devised which do not depart from the scope of the present disclosure as disclosed herein. Accordingly, the scope of the present disclosure should be limited only by the attached claims.

What is claimed is:

1. A user device, comprising:
a scanner for recognizing an access point key;
a network interface for communicating with a private network for a premise;
a processor; and
a non-transitory computer-readable medium operably coupled to the processor, the non-transitory computer-readable medium having computer-readable instructions stored thereon to be executed when accessed by the processor, the instructions comprising:
obtaining an authorization for a user of the user device upon causing the scanner to recognize the access point key within proximity;
allowing only the authorized user to communicate with the private network through the network interface; and
allowing the authorized user to access one or more services on the private network, wherein the access point key associates with an access point, wherein the access point is configured in a relation to the premise to indicate proximity.

2. The user device claim 1, wherein the access point key comprises a QR code, a graphic code, a bar code, or the combination thereof.

3. The user device of claim 1, wherein the private network is an intranet, a BLUETOOTH network, a RFID network, or a NFC network.

4. The user device of claim 1, wherein the instructions further comprise transmitting a location information of the user device to the private network.

5. The user device of claim 1, wherein the accessing the one or more of the services is provided by a user interface loaded to the user device upon authorization.

6. The user device of claim 1, wherein the accessing the one or more of the services is controlled by a timing mechanism, wherein a continued proximity to the premise is confirmed with the timing mechanism.

7. The user device of claim 4, further comprising a location determination component.

8. A system for access point key based services, the system comprising:
one or more servers configured to:
maintain a data structure of a plurality of service information for a plurality of services;
host a private network for a premise, wherein the premise provides one or more of the plurality of services;
configuring one or more access points in a relation to the premise to indicate proximity to the premise, each access point having an access point key;
authorize a user upon recognition of an access point key; and
allow only the authorized user to communicate with the private network, and one or more access points configured by the one or more servers, wherein only the authorized user is allowed to communicate with the private network, and wherein the user accesses the one or more of the plurality of services from the user device upon authorization.

9. The system of claim 8, wherein the private network is an Intranet network, a BLUETOOTH network, a RFID network, a NFC network.

10. The system of claim 8, wherein the access point key is a graphic code, a QR code, a RFID, a bar code, or the combinations thereof.

11. The system of claim 8, wherein the server is further configured to allow access to the service at different extent, depending on different degree of proximity recognized at the access point.

12. The system of claim 8, wherein the users accesses the one or more of the services through a user interface loaded to the user device upon authorization.

13. The system of claim 8, wherein the user accesses the one or more of the services in a manner controlled by a timing mechanism, wherein a continued proximity to the premise is confirmed or monitored with the timing mechanism.

14. The system of claim 8, wherein the data structure further comprises a plurality of user information for a plurality of users.

15. The system of claim 8, wherein each of the plurality of service information comprises at least one of a name, an address, contact information, financial information.

16. The system of claim 8, wherein each of the plurality of user information comprises at least one of a name, a billing address, a delivery address, payment information, favorite information.

17. A non-transitory computer readable medium storing instructions for viewing user posted documents on a website, the instructions when executed by a computer processor comprising functionality to:
maintain a data structure of a plurality of service information for a plurality of services;
maintain a private network for a premise, the premise hosting one or more of the plurality of the services;
configure one or more access points in a relation to the premise to indicate proximity to the premise, each access point having an access point key;
authorize a user upon recognition of an access point key; and
allow only the authorized user to communicate with the private network, wherein the user interacts with an access point to obtain authorization from a user device, wherein the user accesses the one or more of the plurality of services from the user device upon authorization.

18. The non-transitory computer readable medium of claim 17, wherein the functionalities further comprising allowing the user to access the one or more services of the private network.

19. The non-transitory computer readable medium of claim 17, wherein the private network is an Intranet network, a BLUETOOTH network, a RFID network, a NFC network.

20. The non-transitory computer readable medium of claim 17, wherein the access point key is a graphic code, a QR code, a RFID, a bar code, or the combinations thereof.
